(19) United States
(12) Patent Application Publication
(10) Pub. No.: US 2020/0096929 A1
(43) Pub. Date: Mar. 26, 2020

(54) IMAGE FORMING APPARATUS, CONTROL METHOD FOR IMAGE FORMING APPARATUS, AND CONTROL PROGRAM FOR IMAGE FORMING APPARATUS

(71) Applicant: Konica Minolta Inc., Tokyo (JP)

(72) Inventor: Akio UEDA, Tokyo (JP)

(21) Appl. No.: 16/571,545

(22) Filed: Sep. 16, 2019

(30) Foreign Application Priority Data
Sep. 21, 2018 (JP) 2018-177791

(51) Int. Cl. G03G 15/00

(52) U.S. Cl. CPC G03G 15/6523

(57) ABSTRACT

An image forming apparatus includes: an image former that forms an image on a sheet-like recording medium; a cutting processor that cuts, into divided areas, a recording medium conveyed from the image former; a reversing processor having a function to reverse the recording medium cut by the cutting processor; and an image forming data generator that generates image forming data, wherein the image forming data generator generates, the image forming data in which the images are imposed on a front surface and a back surface of the recording medium before the cutting, the image former forms the images on the front surface and the back surface of the recording medium based on the image forming data, and the reversing processor aligns the cutoff sides of the recording media after the cutting, by executing front-back reversal for some of the recording media cut into sheets by the cutting processor.

The present application claims priority under 35 U.S.C. § 119 to Japanese patent Application No. 2018-177791, filed on Sep. 21, 2018, the entire content of which is incorporated herein by reference.

### BACKGROUND

### Technological Field

The present invention relates to an image forming apparatus, a control method for an image forming apparatus, and a control program for an image forming apparatus.

### Description of the Related Art

Among image forming apparatuses that print images on sheet-like recording media, there is an image forming apparatus having functions to: print same images or different images on a plurality of divided areas set on one recording medium; cut the recording medium having the images printed thereon into the respective divided areas; and output the cut recording media.

The image forming apparatus provided with such functions may be required to unify finish of the cut recording media by aligning, in the same direction, cutoff side directions with respect to the printed images on all of the cut recording media that are output.

To satisfy the above requirement, JP 2015-88979 A discloses a technology in which in a case of obtaining substantially two sets of printed matters while allocating images in parallel in a piece of paper, a biding direction and an imposition border side are aligned by performing imposition for one set in accordance with spread order of a booklet and performing imposition for the other set by rotating the other set by 180 degrees and setting the other set in reverse order.

Additionally, J P 2016-112822 A discloses a technology in which when 2×2 or more of same images are laid out on the same piece of paper, unity of cutting finish of each of sets is improved by executing control so as to arrange, in two angular areas in a specific diagonal direction, images rotated from each other by 180 degrees on a front surface of the paper, and further arrange, in two angular areas in the specific diagonal direction, images rotated from each other by 180 degrees on a back surface of the paper.

Furthermore, J P 2016-178518 A discloses a technology in which, when page-reduced images of four pages to be collectively arranged on one recording medium are cut into units of the page-reduced images, arrangement and orientations of the page-reduced images are adjusted by acquiring arrangement positions and orientations of the page-reduced images on the one recording medium such that cutoff sides of the respective page-reduced images at the time of cutting become the same sides when the page reduced images after the cutting are superimposed each other in the same orientation.

However, in respective technologies described above, cutoff side directions with respect to images on respective cut recording media are unified in the same direction, however; it is necessary to execute, as off-line work outside an image forming apparatus, work to align cutting directions of the respective recording media that have been cut and ejected from the image forming apparatus.

### SUMMARY

Considering such a situation, the present invention is directed to providing an image forming apparatus, a control method for an image forming apparatus, and a control program for an image forming apparatus, in which output can be performed while aligning cutoff sides arranged in the same direction with respect to images on respective cut recording media.

To achieve the abovementioned object, according to an aspect of the present invention, an image forming apparatus reflecting one aspect of the present invention comprises: an image former that forms an image on a sheet-like recording medium; a cutting processor that cuts, into a plurality of divided areas, a recording medium conveyed from the image former; a reversing processor having a function to reverse the recording medium cut by the cutting processor; and an image forming data generator that generates image forming data in which an image to be formed on the recording medium is imposed in each of the divided areas, wherein the image forming data generator generates, based on settings of an image forming job, the image forming data in which the images are imposed on a front surface and a back surface of the recording medium before the cutting such that cutoff sides of recording media after the cutting are arranged in a same direction with respect to the images formed on the recording media after the cutting, the image former forms the images on the front surface and the back surface of the recording medium based on the image forming data, and the reversing processor aligns the cutoff sides of the recording media after the cutting, by executing front-back reversal for some of the recording media cut into a plurality of sheets by the cutting processor.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1 is a schematic view illustrating an entire structure of an image forming apparatus according to each embodiment of the present invention;

FIG. 2 is a block diagram to describe a configuration of a controller in the image forming apparatus according to each embodiment of the present invention;

FIG. 3 is a process diagram illustrating a control method for an image forming apparatus according to a first embodiment;

FIG. 4 is a process diagram illustrating a control method for an image forming apparatus according to a second embodiment;

FIG. 5 is a process diagram illustrating a control method for an image forming apparatus according to a third embodiment;

FIG. 6 is a flowchart (Part 1) illustrating a control method for an image forming apparatus according to a fourth embodiment;

FIG. 7 is a flowchart (Part 2) illustrating the control method for the image forming apparatus according to the fourth embodiment;

FIG. 8 is a flowchart (Part 3) illustrating the control method for the image forming apparatus according to the fourth embodiment;

FIG. 9 is a process diagram illustrating a control method for an image forming apparatus according to a fifth embodiment;

FIG. 10 is a process diagram illustrating a control method for an image forming apparatus according to a sixth embodiment;

FIG. 11 is a flowchart illustrating a control method for an image forming apparatus according to a seventh embodiment; and

FIG. 12 is a process diagram illustrating a control method for an image forming apparatus according to a seventh embodiment.

### DETAILED DESCRIPTION OF EMBODIMENTS

Hereinafter, one or more embodiments of the present invention will be described with reference to the drawings. However, the scope of the invention is not limited to the disclosed embodiments. Note that a constituent element common among the respective embodiments will be denoted by the same reference sign and a description thereof will be partly omitted.

<<Schematic Structure of Image Forming Apparatus in Embodiments>>

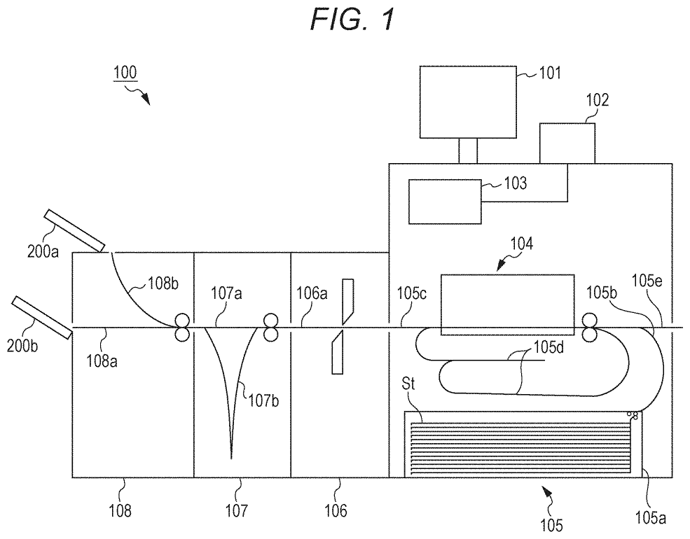

FIG. 1 is a structural view of an image forming apparatus 100 according to each embodiment when viewed from a front side (front surface). The image forming apparatus 100 is an apparatus having functions to: print same images or different images respectively on a plurality of divided areas set on one recording medium; cut the recording medium having the images printed thereon into units of the divided areas; and output the cut recording media. Such an image forming apparatus 100 includes an operation part 101, an image data receiver 102, a controller 103, an image former 104, a medium feeder 105, a cutting processor 106, a reversing processor 107, and an ejection processor 108. A configuration of each of these members is as follows.

<Operation Part 101>

The operation part 101 is a part in which condition settings for an image forming job executed by using the image forming apparatus 100 are input, and a display panel and operation buttons are provided. The operation buttons may be a touch panel integrally provided with the display panel. The settings for an image forming job by the operation part 101 include, for example, condition settings for an image forming job, such as the number of divisions in a case of cutting and dividing one recording medium into a plurality of areas, and arrangement directions of cutoff sides with respect to images formed on the recording medium, and the settings further include a start command for an image forming job and the like. Note that the above-described operation part 101 may be a personal computer or another external device connected to the image forming apparatus 100.

<Image Data Receiver 102>

The image data receiver 102 is used to receive, for example, image data received from a personal computer or another external device connected to the image forming apparatus 100 and may be an input/output interface. Additionally, the image data receiver 102 may include a platen and a reading device that reads an image of a document placed on the platen.

<Controller 103>

The controller 103 is used to control operations of the respective parts of the image forming apparatus 100 in accordance with operation at the operation part 101 or a reception signal from the external device such as the personal computer connected to the image forming apparatus 100, and includes a calculator. The calculator is hardware that is used as a so-called computer. The calculator includes a central processing unit (CPU), a read only memory (ROM), and a random access memory (RAM). Furthermore, a non-volatile storage and a network interface are provided.

The controller 103 executes characteristic control described in a control method for the image forming apparatus 100 described below. A procedure of this control is stored in the ROM or stored in the RAM after being loaded from the external device as a control program to control the operations of the respective parts of the image forming apparatus 100.

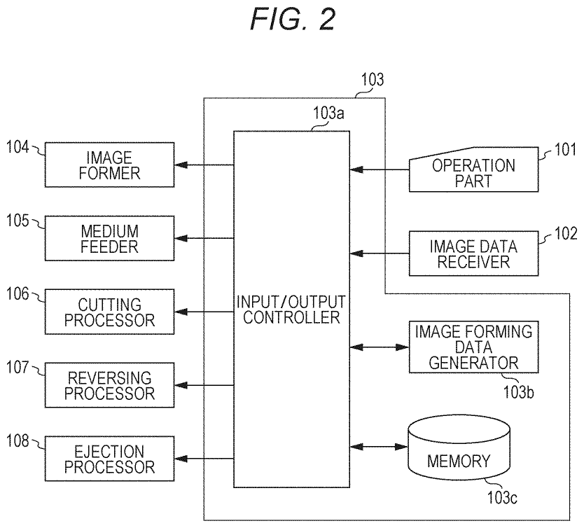

FIG. 2 is a block diagram to describe the configuration of the controller 103 in the image forming apparatus 100 according to each embodiments of the present invention. As illustrated in this block diagram, the controller 103 includes an input/output controller 103a, an image forming data generator 103b, and a memory 103c.

[Input/Output Controller 103a]

The input/output controller 103a is connected to: the respective parts such as the operation part 101 and the image data receiver 102 constituting the image forming apparatus 100; the image forming data generator 103b; and the memory 103c. The input/output controller 103a controls the input from the operation part 101, the image data receiver 102, and the external device, and further controls driving of the image former 104, the medium feeder 105, the cutting processor 106, the reversing processor 107, and the ejection processor 108 based on the control program stored in the controller 103. The driving control for the respective parts by the above-described input/output controller 103a will be described in detail in a later-described control method for an image forming apparatus.

[Image Forming Data Generator 103b]

The image forming data generator 103b generates image forming data in which images of respective pages based on image data stored in the memory 103c are laid out by imposing the images on a front surface and a back surface of a recording medium based on settings for an image forming job input from the operation part 101 or the external device. Particularly, the image forming data generator 103b includes a program to generate the image forming data in which the images are imposed on the front surface and the back surface of the recording medium such that cutoff sides of recording media after the cutting are aligned in the same direction with respect to the images formed in the recording media after the cutting. The image forming data generated by such an image forming data generator 103b will be described in detail in the control method for the image forming apparatus.

[Memory 103c]

The memory 103c stores: a control program in order that the CPU constituting the controller 103 may control the respective parts of the image forming apparatus 100; and image data received from the image data receiver 102. Additionally, the memory 103c stores: information associated with an image forming job input from the operation part 101 or the external device; and the image forming data generated by the image forming data generator 103b.

<Image Former 104>

Referring back to FIG. 1, the image former 104 is a part that forms an image on a main surface of a sheet-like recording medium St by printing in accordance with a command from the controller 103. For example, the image former 104 is an electrophotographic type, includes a toner image former, an intermediate transfer belt, a fixing device, and the like, and forms a toner image on one main surface of a recording medium.

<Medium Feeder 105>

The medium feeder 105 is a part that feeds a recording medium to the image former 104 in accordance with a command from the controller 103. Such a medium feeder 105 includes a medium storage part 105a that stores a large number of recording media St, and a medium feeding path 105b that feeds, one by one, the recording media St stored in the medium storage part 105a to the image former 104. Additionally, the medium feeder 105 further includes a medium ejection path 105c that conveys, to the subsequent cutting processor 106, a recording medium having an image printed in the image former 104.

Furthermore, the medium feeder 105 includes a medium reversing/conveyance path 105d that executes front-back reversal in a conveyance direction for a recording medium St having an image printed in the image former 104, and feds the reversed recording medium to the image former 104 again. With this structure, images can be printed on the two main surfaces including the front and back surfaces of the recording medium in the image former 104.

Note that the medium feeder 105 may include a second medium feeding path 105e that feeds, to the image former 104, the recording media St one by one from an external medium storage part (not illustrated).

<Cutting Processor 106>

The cutting processor 106 cuts, into a plurality of divided areas, a recording medium St conveyed from the image former 104 in accordance with a command from the controller 103. Particularly, this cutting processor 106 cuts the recording medium St at a center in the conveyance direction in accordance with the command from the controller 103, and sequentially conveys, to the reversing processor 107, the recording medium St cut into two sheets. Such a cutting processor 106 includes: a medium conveyance path 106a continuous from the medium ejection path 105c of the medium feeder 105; and a cutting machine 106b arranged in a manner interposing the medium conveyance path 106a.

<Reversing Processor 107>

The reversing processor 107 conveys the recording medium St conveyed from the cutting processor 106 to the subsequent ejection processor 108 as it is, or reverses and then conveys the recording medium St to the subsequent ejection processor 108 in accordance with a command from the controller 103. Such a reversing processor 107 includes: a medium conveyance path 107a that conveys the recording medium St sent from the cutting processor 106 to the ejection processor 108 as it is; and a reverse conveyance path 107b that executes the front-back reversal in the conveyance direction and conveys the recording medium to the ejection processor 108. The reverse conveyance path 107b reverses the recording medium St in the conveyance direction thereof. More specifically, the reverse conveyance path 107b reverses the recording medium St along a plane formed by the conveyance direction of the recording medium St and a normal direction with respect to a main surface (front surface or back surface) of the recording medium St.

<Ejection Processor 108>

The ejection processor 108 is a part that distributes and ejects, in accordance with a command from the controller 103 as necessary, each recording medium St conveyed from the reversing processor 107. Such an ejection processor 108 includes; a first ejection path 108a that ejects each recording media St sent from the reversing processor 107 to a first tray 200a; and a second ejection path 108b that ejects each recording medium St to a second tray 200b. Note that the ejection processor 108 may also distribute and eject each recording media St sent from the reversing processor 107 to three or more different trays.

<<Control Method for Image Forming Apparatus>>

Next, a control method for the image forming apparatus 100 including the above-described parts will be described with reference to FIG. 1 and FIG. 2 as well as the drawings illustrating respective embodiments. The control method for the image forming apparatus 100 described below is implemented by the CPU constituting the input/output controller 103a and controlling driving of the respective parts of the image forming apparatus 100 based on settings input from the operation part 101 and image data received from the image data receiver 102 and further based on the control program for the image forming apparatus stored in the ROM or the RAM.

Additionally, the control method for the image forming apparatus 100 in each of the embodiments described below executes, as basic operations; a procedure to form images on front and back surfaces of a recording medium St; a procedure to cut the recording medium St having the images formed thereon; and a procedure to eject only some of recording media St cut into a plurality of sheets.

Note that, in the following description, the description will be provided assuming that the conveyance direction of each recording medium St at the time of image formation is a leftward direction in the drawings. Therefore, in the following description, a left half surface of each recording medium St represents a half surface on a leading end side in the conveyance direction of the recording medium St. Additionally, a right half surface of each recording medium St represents a half surface on a tail end side in the conveyance direction of the recording medium St.

### First Embodiment: Basic Operation 1

—Production Control for Single-Sided Printed Matter—

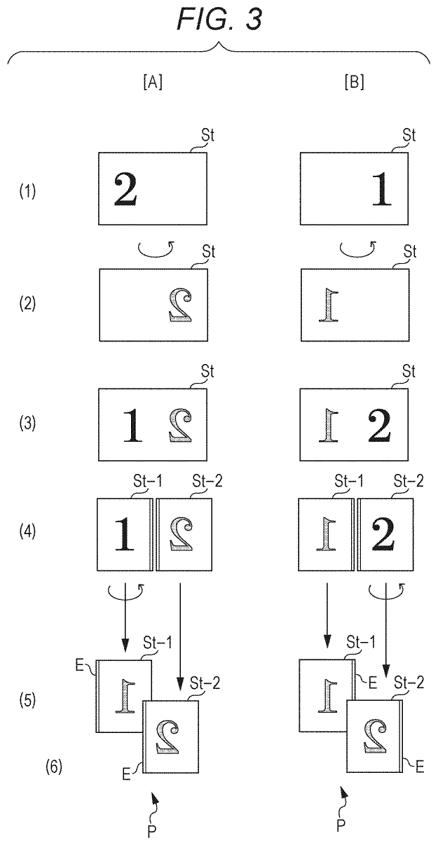

FIG. 3 is a process diagram to describe a control method for an image forming apparatus in a first embodiment and also is a process diagram illustrating a basic operation 1 of the control method for the image forming apparatus. The control method illustrated in the drawing is an exemplary control method in a case of unifying, to either a right side or a left side, directions of cutoff sides E with respect to images when the images of two pages are printed on one recording medium St and the recording medium St is cut into two divided areas to produce single-sided printed matters P. Here, a description will be provided for the case of collectively printing the images of two different pages on one recording medium St, but the control method can be similarly executed in a case of repeatedly printing same images on one recording medium St.

[In Case where Cutoff Side is Set on Right Side]

A column [A] in FIG. 3 illustrates an exemplary case of obtaining single-sided printed matters P in each of which a cutoff side E is arranged on a right side of an image printed on a recording medium St.

In this case, as illustrated in (1) of the column [A] in FIG. 3, an image former 104 prints an image of a second page on a left half surface on one main surface of the recording medium St fed from a medium feeder 105 based on image forming data generated in an image forming data generator 103b.

Next, as illustrated in (2) of the column [A] in FIG. 3, the medium feeder 105 executes front-back reversal in a conveyance direction for the recording medium St having the image of the second page formed thereon. Then, the recording medium St subjected to the front-back reversal is fed to the image former 104 again.

Next, as illustrated in (3) of the column [A] in FIG. 3, the image former 104 prints an image of a first page on a left half surface on the other main surface of the recording medium St based on the image forming data generated in the image forming data generator 103b. Additionally, the medium feeder 105 conveys, to a cutting processor 106, the recording medium St having the images on both surfaces thereof.

After that, as illustrated in (4) of the column [A] in FIG. 3, the cutting processor 106 cuts, into two recording media St-1 and St-2 at a center in the conveyance direction, the recording medium St conveyed from the image former 104. Furthermore, the cut recording media St-1 and St-2 are sequentially conveyed to a reversing processor 107.

Next, as illustrated in (5) of the column [A] in FIG. 3, among the recording media St-1 and St-2 cut into two sheets, the reversing processor 107 executes the front-back reversal in the conveyance direction for the recording medium St-1 positioned at a first sheet (on a leading end side) in the conveyance direction and conveys the recording medium St-1 to an ejection processor 108 to eject the recording medium St-1 from the ejection processor 108.

Subsequently, as illustrated in (6) of the column [A] in FIG. 3, the reversing processor 107 conveys, as it is, the recording medium St-2 positioned at a second sheet (on a tail end side) in the conveyance direction to the ejection processor 108, and ejects the recording medium St-2 onto the recording medium St-1 that is the first sheet.

In the above-described manner, it is possible to obtain the single-sided printed matters P in which the recording media St-1 and St-2 having the cutoff sides E on the right side with respect to the respective images are stacked in the page order in a state in which the image-formed surfaces and the cutoff sides E are oriented in the same direction.

[In Case where Cutoff Side is Set on Left Side]

A column [B] in FIG. 3 illustrates an exemplary case of obtaining single-sided printed matters P in each of which a cutoff side E is arranged on a left side of an image printed on a recording medium St.

In this case, as illustrated in (1) of the column [B] in FIG. 3, the image former 104 prints an image of a first page on a right half surface on one main surface of the recording medium St fed from the medium feeder 105 based on the image forming data generated in the image forming data generator 103b.

Next, as illustrated in (2) of the column [B] in FIG. 3, the medium feeder 105 executes the front-back reversal in the conveyance direction for the recording medium St having the image of the first page formed thereon. Then, the recording medium St subjected to the front-back reversal is fed to the image former 104 again.

Next, as illustrated in (3) of the column [B] in FIG. 3, the image former 104 prints an image of a second page on a right half surface on the other main surface of the recording medium St based on the image forming data generated in the image forming data generator 103b. Additionally, the medium feeder 105 conveys, to the cutting processor 106, the recording medium St having the images on both surfaces thereof.

After that, as illustrated in (4) of the column [B] in FIG. 3, the cutting processor 106 cuts, into two recording media St-1 and St-2 at a center in the conveyance direction, the recording medium St conveyed by the medium feeder 105 from the image former 104. Furthermore, the cut recording media St-1 and St-2 are sequentially conveyed to the reversing processor 107.

Next, as illustrated in (5) of the column [B] in FIG. 3, among the recording media St-1 and St-2 cut into two sheets, the reversing processor 107 conveys, as it is, the recording medium St-1 positioned at a first sheet (on the leading end side) in the conveyance direction to the ejection processor 108, and ejects the recording medium St-1 from the ejection processor 108.

Subsequently, as illustrated in (6) of the column [B] in FIG. 3, the reversing processor 107 executes the front-back reversal in the conveyance direction for the recording medium St-2 positioned at a second sheet (on the tail end side) in the conveyance direction, and conveys the recording medium St-2 to the ejection processor 108 to eject the recording medium St-2 onto the recording medium St-1 that is the first sheet.

In the above-described manner, it is possible to obtain the single-sided printed matters P in which the recording media St-1 and St-2 having the cutoff sides E on the left side with respect to the respective images are stacked in the page order in a state in which the image-formed surfaces and the cutoff sides E are oriented in the same direction.

In the above-described basic operation 1, the cutoff sides E can be set on the right side or the left side with respect to the images by: swapping layouts of the images on the respective front and back main surfaces of the recording medium St before the cutting; and switching, to either the recording media St-1 or St-2 after the cutting, the recording medium to be reversed and ejected.

### Second Embodiment: Basic Operation 2

—Production Control for Double-Sided Printed Matter—

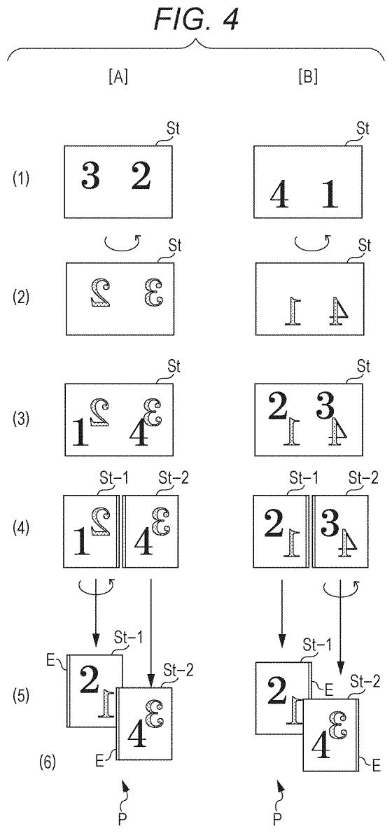

FIG. 4 is a process diagram to describe a control method for an image forming apparatus in a second embodiment and also is the process diagram illustrating a basic operation 2 of the control method for the image forming apparatus. The control method illustrated in the drawing is an exemplary control method in a case of unifying, to a right side or a left side, arrangement directions of cutoff sides E with respect to an image of a first page at the time of producing double-sided printed matters P by collectively printing images of four pages on both surfaces of one recording medium St and then cutting the recording medium St into two divided areas. Here, the case of collectively printing images of different pages on the one recording medium St will be described, but the control method can be similarly executed in a case of repeatedly printing same images on one surface side of one recording medium St.

[In Case where Cutoff Side is Set on Right Side]

A column [A] in FIG. 4 illustrates an exemplary case of obtaining double-sided printed matters P in each of which a cutoff side E is arranged on a right side of an image printed as a first page on a recording medium St.

In this case, as illustrated in (1) of the column [A] in FIG. 4, an image former 104 prints an image of a third page on a left half surface and prints an image of a second page on a right half surface on one main surface of the recording medium St fed from a medium feeder 105 based on image forming data generated in an image forming data generator 103b.

Next, as illustrated in (2) of the column [A] in FIG. 4, the medium feeder 105 executes front-back reversal in a conveyance direction for the recording medium St having the one main surface formed with the images. Then, the recording medium St subjected to the front-back reversal is fed to the image former 104 again.

Next, as illustrated in (3) of the column [A] in FIG. 4, the image former 104 prints an image of a first page on a left half surface and prints an image of a fourth page on a right half surface on the other main surface of the recording medium St based on the image forming data generated in the image forming data generator 103b. Additionally, the medium feeder 105 conveys, to a cutting processor 106, the recording medium St having the images on both surfaces thereof.

After that, as illustrated in (4) of the column [A] in FIG. 4, the cutting processor 106 cuts, into two recording media St-1 and St-2 at a center in the conveyance direction, the recording medium St conveyed from the image former 104. Furthermore, the cut recording media St-1 and St-2 are sequentially conveyed to a reversing processor 107.

Next, as illustrated in (5) of the column [A] in FIG. 4, among the recording media St-1 and St-2 cut into two sheets, the reversing processor 107 executes the front-back reversal in the conveyance direction for the recording medium St-1 positioned at a first sheet (on a leading end side) in the conveyance direction and conveys the recording medium St-1 to the ejection processor 108, and then ejects the recording medium St-1 from the ejection processor 108.

Subsequently, as illustrated in (6) of the column [A] in FIG. 4, the reversing processor 107 conveys, as it is, the recording medium St-2 positioned at a second sheet (on a tail end side) in the conveyance direction to the ejection processor 108, and ejects the recording medium St-2 onto the recording medium St-1 that is the first sheet.

In the above-described manner, it is possible to obtain the double-sided printed matters P in which the recording media St-1 and St-2 having the cutoff sides E on the right side with respect to the image of the first page are stacked in the page order in a state in which the cutoff sides E are oriented in the same direction.

[In Case where Cutoff Side is Set on Left Side]

A column [B] in FIG. 4 illustrates an exemplary case of obtaining a double-sided printed matters P in each of which a cutoff side E is arranged on a left side of an image printed as a first page on a recording medium St.

In this case, as illustrated in (1) of the column [B] in FIG. 4, the image former 104 prints the image of the first page on a right half surface and prints an image of a fourth page on a left half surface on one main surface of the recording medium St based on the image forming data generated in the image forming data generator 103b.

Next, as illustrated in (2) of the column [B] in FIG. 4, the medium feeder 105 executes the front-back reversal in the conveyance direction for the recording medium St having the one main surface formed with the images. Then, the recording medium St subjected to the front-back reversal is fed to the image former 104 again.

Next, as illustrated in (3) of the column [B] in FIG. 4, the image former 104 prints an image of a third page on a right half surface and prints an image of a second page on a left half surface on the other main surface of the recording medium St based on the image forming data generated in the image forming data generator 103b. Additionally, the medium feeder 105 conveys, to the cutting processor 106, the recording medium St having the images on both surfaces thereof.

After that, as illustrated in (4) of the column [B] in FIG. 4, the cutting processor 106 cuts, into two recording media St-1 and St-2 at a center in the conveyance direction, the recording medium St conveyed from the image former 104. Furthermore, the cut recording media St-1 and St-2 are sequentially conveyed to the reversing processor 107.

Next, as illustrated in (5) of the column [B] in FIG. 4, among the recording media St-1 and St-2 cut into two sheets, the reversing processor 107 conveys, as it is, the recording medium St-1 positioned at a first sheet (on the leading end side) in the conveyance direction to the ejection processor 108, and ejects the recording medium St-1 from the ejection processor 108.

Subsequently, as illustrated in (6) of the column [B] in FIG. 4, the reversing processor 107 executes the front-back reversal in the conveyance direction for the recording medium St-2 positioned at a second sheet (on the tail end side) in the conveyance direction, and conveys the recording medium to the ejection processor 108, and then ejects the recording medium St-2 onto the recording medium St-1 that is the first sheet.

In the above-described manner, it is possible to obtain the double-sided printed matters P in which the recording media St-1 and St-2 having the cutoff sides E on the left side with respect to the image of the first page are stacked in the page order in a state in which the cutoff sides E are oriented in the same direction.

In the above-described basic operation 2, the cutoff sides E can be set on the right side or the left side with respect to the image of the first page by: swapping layouts of the images on the respective front and back main surfaces of the recording medium St before cutting; and switching, to either the recording media St-1 or St-2 after the cutting, the recording medium to be reversed and ejected.

### Third Embodiment: Basic Operation 3

—Production Control for Landscape-Mode Printed Matter—

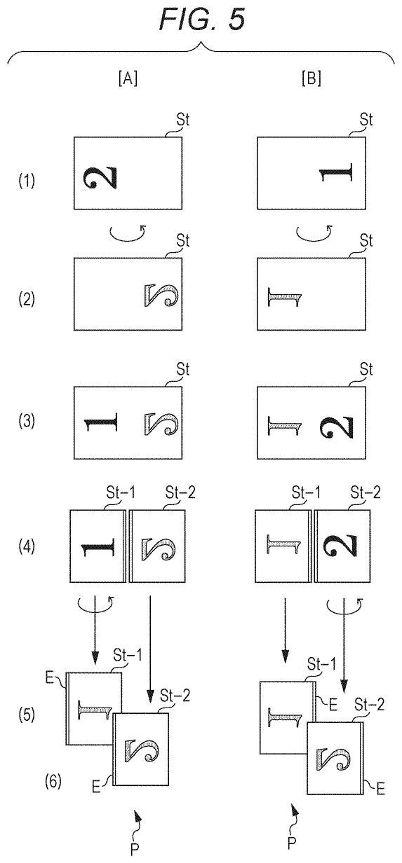

FIG. 5 is a process diagram to describe a control method for an image forming apparatus in a third embodiment and also is a process diagram illustrating a basic operation 3 of the control method for the image forming apparatus. The control method illustrated in the drawing is an exemplary control method in a case of unifying, to either an upper side or a lower side, arrangement directions of cutoff sides E with respect to images when the images of two pages are collectively printed on one recording medium St and then the recording medium St is cut into two areas to produce single-sided printed matters P. In this case, a conveyance direction of the recording medium St is a vertical direction of each of the images formed on the recording medium St. Here, a description will be provided for the case of collectively printing the images of two different pages on one recording medium St, but the control method can be similarly executed in a case of repeatedly printing same images on one recording medium St.

[In Case where Cutoff Side is Set on Lower Side]

A column [A] in FIG. 5 illustrates an exemplary case of obtaining single-sided printed matters P in each of which a cutoff side E is arranged on a lower side of an image printed on a recording medium St.

In this case, as illustrated in (1) of the column [A] in FIG. 5, an image former 104 rotates an image of a second page leftward by 90 degrees and prints the image on a left half surface on one main surface of the recording medium St based on image forming data generated in an image forming data generator 103b.

Next, as illustrated in (2) of the column [A] in FIG. 5, a medium feeder 105 executes front-back reversal in a conveyance direction of the recording medium St for the recording medium St having the one main surface formed with the image. Then, the recording medium St subjected to the front-back reversal is fed to the image former 104 again.

Next, as illustrated in (3) of the column [A] in FIG. 5, the image former 104 rotates an image of a first page leftward by 90 degrees and prints the image on a left half surface on the other main surface of the recording medium St based on image forming data generated in an image forming data generator 103b. Additionally, the medium feeder 105 conveys, to a cutting processor 106, the recording medium St having the images on both surfaces thereof.

After that, as illustrated in (4) of the column [A] in FIG. 5, the cutting processor 106 cuts, into two recording media St-1 and St-2 at a center in the conveyance direction, the recording medium St conveyed from the image former 104. Furthermore, the cut recording media St-1 and St-2 are sequentially conveyed to a reversing processor 107.

Next, as illustrated in (5) of the column [A] in FIG. 5, among the recording media St-1 and St-2 cut into two sheets, the reversing processor 107 executes the front-back reversal in the conveyance direction for the recording medium St-1 positioned at a first sheet (on a leading end side) in the conveyance direction and conveys the recording medium St-1 to an ejection processor 108, and then ejects the recording medium St-1 from the ejection processor 108.

Subsequently, as illustrated in (6) of the column [A] in FIG. 5, the reversing processor 107 conveys, as it is, the recording medium St-2 positioned at a second sheet (on a tail end side) in the conveyance direction to the ejection processor 108 and ejects the recording medium St-2 onto the recording medium St-1 that is the first sheet.

In the above-described manner, it is possible to obtain the single-sided printed matters P in which the recording media St-1 and St-2 having the cutoff sides E on the lower side with respect to the respective images are stacked in the page order in a state in which the image-formed surfaces and the cutoff sides E are oriented in the same direction.

[In Case where Cutoff Side is Set on Upper Side]

A column [B] in FIG. 5 illustrates an exemplary case of obtaining single-sided printed matters P in each of which a cutoff side E is arranged on au upper side of an image printed on a recording medium St.

In this case, as illustrated in (1) of the column [B] in FIG. 5, the image former 104 rotates an image of a first page leftward by 90 degrees and prints the image on a right half surface on one main surface of the recording medium St based on the image forming data generated in the image forming data generator 103b.

Next, as illustrated in (2) of the column [B] in FIG. 5, the medium feeder 105 executes the front-back reversal in the conveyance direction of the recording medium St for the recording medium St having the one main surface formed with the images. Then, the recording medium St subjected to the front-back reversal is fed to the image former 104 again.

Next, as illustrated in (3) of the column [B] in FIG. 5, the image former 104 rotates an image of a second page leftward by 90 degrees and prints the image on a right half surface on the other main surface of the recording medium St based on the image forming data generated in the image forming data generator 103b. Additionally, the medium feeder 105 conveys, to the cutting processor 106, the recording medium St having the images on both surfaces thereof.

After that, as illustrated in (4) of the column [B] in FIG. 5, the cutting processor 106 cuts, into two recording media St-1 and St-2 at a center in the conveyance direction, the recording medium St conveyed from the image former 104. Furthermore, the cut recording media St-1 and St-2 are sequentially conveyed to the reversing processor 107.

Next, as illustrated in (5) of the column [B] in FIG. 5, among the recording media St-1 and St-2 obtained by cutting the recording medium St into two sheets, the reversing processor 107 conveys, as it is, the recording medium St-1 positioned at a first sheet (on the leading end side) in the conveyance direction to the ejection processor 108, and ejects the recording medium St-1 from the ejection processor 108.

Subsequently, as illustrated in (6) of the column [B] in FIG. 5, the reversing processor 107 executes the front-back reversal in the conveyance direction for the recording medium St-2 positioned at a second sheet (on the tail end side) in the conveyance direction, and conveys the recording medium to the ejection processor 108, and then ejects the recording medium St-2 onto the recording medium St-1 that is the first sheet.

In this manner, it is possible to obtain the single-sided printed matters P in which the recording media St-1 and St-2 having the cutoff sides E on the upper side with respect to the respective images are stacked in the page order in a state in which image-formed surfaces and the cutoff sides E are oriented in the same direction.

In the above-described basic operation 3, the cutoff sides E can be arranged on the upper side or the lower side with respect to the images by: swapping layouts of the images on the respective front and back main surfaces of the recording medium St before cutting; and switching, to either the recording media St-1 or St-2 after the cutting, the recording medium to be reversed and ejected. Furthermore, the rotation direction of the image may also be rightward by 90 degrees, and an appropriate direction is selected for the layout swapping and the reverse/ejection switching in accordance with the rotation direction of the image.

### Fourth Embodiment

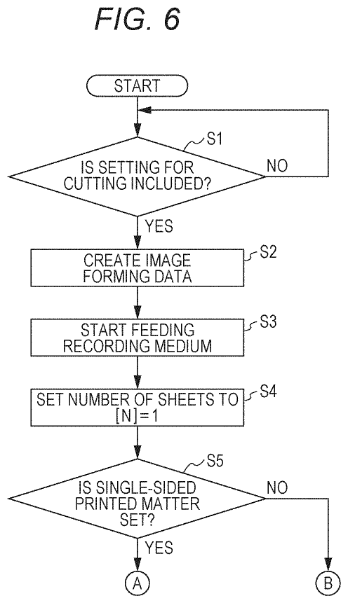

FIG. 6 to FIG. 8 are flowcharts (Part 1) to (Part 3) illustrating a control method for an image forming apparatus of a fourth embodiment. The control method illustrated in these flowcharts is a control method in a case of applying basic operations 1 and 2 of a first embodiment and a second embodiment described above and printing preset prescribed number of sets of printed matters P of a plurality of pages. In the following, the control method of the fourth embodiment will be described in the order illustrated in the flowcharts of FIG. 6 to FIG. 8 while referring to FIG. 1 to FIG. 4.

[Step S1]

First, in step S1 of FIG. 6, in a case where an image forming job is input from an operation part 101 or an external device in an image forming apparatus 100, an input/output controller 103a determines whether settings of the image forming job include a setting to cut a recording medium St. The setting to cut the recording medium St, which is to be determined here is, for example, a setting to cut, into two areas at a center in a conveyance direction, the recording medium St conveyed in a longitudinal direction.

In a case where the image forming job including such a setting is input, the input/output controller 103a determines that the setting for cutting is included (YES), and processing proceeds to next step S2. In other cases, the processing returns to step S1 and waits until it is determined that the setting for cutting is included (YES).

[Step S2]

In step S2, an image forming data generator 103b generates image forming data based on condition settings in the image forming job input from the operation part 101 or the external device. In the image forming data, images are imposed and laid out on a front surface and a back surface of each of the two areas obtained by cutting the recording medium at the center as described above in the basic operations 1 to 3.

[Step S3]

In step S3, the input/output controller 103a commands a medium feeder 105 to feed a recording medium St to an image former 104. Consequently, the medium feeder 105 starts feeding the recording medium to the image former 104.

[Step S4]

In step S4, the input/output controller 103a executes processing to set, to [N]=1, the number of sheets [N] of the recording medium to be printed for this image forming job.

[Step S5]

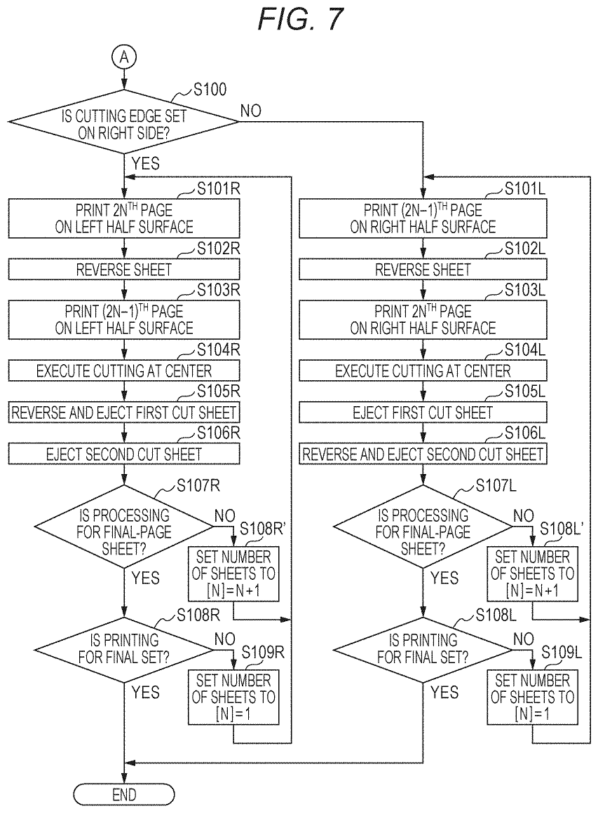

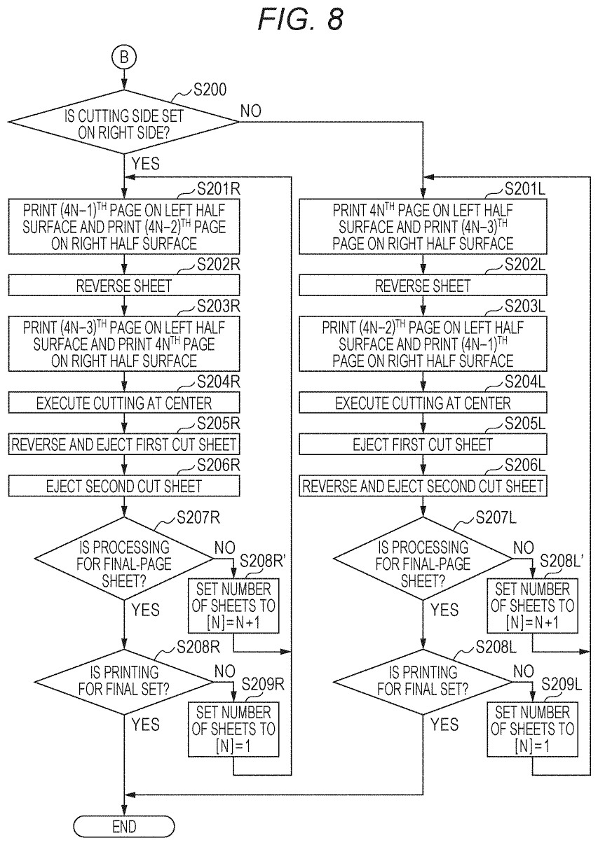

In step S5, the input/output controller 103a determines whether the image forming job input from the operation part 101 is set as a production job of a single-sided printed matter. Here, the single-sided printed matter means that a printed matter output from the image forming apparatus 100 is single-sided printed. In a case where the input/output controller 103a determines that the single-sided printed matter is to be produced (YES), the processing proceeds to the next step S100 (FIG. 7) and controls the production of the single-sided printed matter. On the other hand, in a case where the input/output controller 103a determines that the single-sided printed matter is not to be produced (NO), the processing proceeds to the next step S200 (FIG. 8) and controls production of a double-sided printed matter.

[Step S100]

First, in step S100 of FIG. 7, the input/output controller 103a determines whether a cutoff side is set on a right side in the settings of the image forming job input from the operation part 101. In a case of determining that the cutoff side is set on the right side (YES), the processing proceeds to step S101R, and control is executed to obtain a single-sided printed matter in which the right side with respect to an image is set as the cutoff side. On the other hand, in a case of determining that the cutoff side is not set on the right side (NO), the processing proceeds to step S101L, and control is executed to obtain a single-sided printed matter in which a left side with respect to an image is set as the cutoff side.

[Step S101R to Step S106R]

In steps S101R to S106R, the basic operation 1 illustrated above in the column [A] of FIG. 3 is executed, and the control is executed to obtain a recording medium in which the cutoff side E is set on the right side with respect to the image and printing is performed on a single side.

In other words, in step S101R, the image former 104 prints an image of a 2N^{th} page on a left half surface of each recording medium St ((1) in a column [A] of FIG. 3). Next, in step S102R, the medium feeder 105 executes front-back reversal in the conveyance direction for the recording medium St ((2) in the column [A] of FIG. 3). Next, in step S103R, the image former 104 prints an image of a (2N−1)^{th} page on a left half surface of the recording medium St ((3) in the column [A] of FIG. 3).

After that, in step S104R, the cutting processor 106 cuts the recording medium St into two recording media St-1 and St-2 at the center in the conveyance direction ((4) of the column [A] of FIG. 3). Next, in step S105R, a reversing processor 107 executes the front-back reversal in the conveyance direction for the cut recording medium St-1 that is a first sheet, and ejects the recording medium St-1 from an ejection processor 108 ((5) in the column [A] of FIG. 3). Subsequently, in step S106R, the reversing processor 107 conveys, as it is, a recording medium St-2 that is a second sheet in the conveyance direction to the ejection processor 108, and ejects the recording medium St-2 onto the recording medium St-1 that is the first page ((6) in the column [A] of FIG. 3).

[Step S107R]

After that, in step S107R, the input/output controller 103a determines whether the above-described processing in steps S101R to S106R is processing for a final-page sheet of a set. Here, in a case where the processing in the above-described steps S101R to S106R includes processing to produce a final page of the set, it is determined that the processing is for the final-page sheet (YES), and the processing proceeds to step S108R. On the other hand, in a case where the processing to produce the final page of the set is not included, it is determined that the sheet is not the final-page sheet of the set (NO), and the processing proceeds to step S108R′.

[Step S108R′]

In step S108R′, the input/output controller 103a executes processing to set the number of sheets to [N]=N+1, returns to earlier step S101R, and repeats subsequent steps.

[Step S108R]

On the other hand, in step S108R, the input/output controller 103a determines whether the processing in steps S101R to S106R is the processing for a final set out of the preset prescribed number of sets. At this time, in a case where the current number of sets has reached the prescribed number of sets preset in the image forming job input from the operation part 101, the input/output controller 103a determines that the set is the final set (YES), and terminates the processing. On the other hand, in a case where the number of sets has not reached the prescribed number of sets, it is determined that the set is not the final set (NO), and the processing proceeds to step S109R.

[Step S109R]

In step S109R, the input/output controller 103a executes processing to set the number of sheets to [N]=1, and returns to earlier step S101R to repeat the subsequent steps.

[Step S101L to Step S106L]

On the other hand, in a case of determining that the cutoff side is not set on the right side (NO) in step S100, the processing proceeds to step S101L, and control is executed to obtain a single-sided printed matter in which the left side with respect to the image is set as the cutoff side.

In steps S101L to S106L, the basic operation 1 illustrated above in (1) to (6) of the column [B] in FIG. 3 is executed, and the control is executed to obtain a recording medium in which the left side with respect to the image is set as the cutoff side E and printing is performed on a single side.

In other words, in step S101L, the image former 104 prints an image of a (2N−1)^{th} page on a right half surface of each recording medium St ((1) in column [B] of FIG. 3). Next, in step S102L, the medium feeder 105 executes the front-back reversal in the conveyance direction for the recording medium St ((2) in the column [B] of FIG. 3). Next, in step S103L, the image former 104 prints an image of a 2N^{th} page on a right half surface of the recording medium St ((3) in column [B] of FIG. 3).

After that, in step S104L, the cutting processor 106 cuts the recording medium St into two recording media St-1 and St-2 at the center in the conveyance direction ((4) of the column [B] of FIG. 3). Next, in step S105L, the reversing processor 107 conveys, as it is, the cut recording medium St-1 that is a first sheet to the ejection processor 108 and ejects the recording medium St-1 ((5) in the column [B] of FIG. 3). Subsequently, in step S106L, the reversing processor 107 executes the front-back reversal in the conveyance direction for the recording medium St-2 that is a second sheet, and ejects the recording medium St-2 from the ejection processor 108 onto the recording medium St-1 that is the first page ((6) in the column [B] of FIG. 3).

[Step S107L to Step S109L]

Furthermore, in subsequent steps S107L to S109L, processing similar to the processing executed in steps S107R to S109R described above is executed.

[Step S200]

On the other hand, in step S200 of FIG. 8, in other words, in step S200 that is processing in the case of determining that the single-sided printed matter is not to be produced (NO) in step S5 (see FIG. 6), the input/output controller 103a determines whether the cutoff side is set on the right side in the settings of the image forming job input from the operation part 101. In a case of determining that the cutoff side is set on the right side (YES), the processing proceeds to step S201R, and control is executed to obtain a double-sided printed matter in which the cutoff side is set on the right side with respect to an image. On the other hand, in a case of determining that the cutoff side is not set on the right side (NO), the processing proceeds to step S201L, and control is executed to obtain a double-sided printed matter in which the cutoff side is set on the left side with respect to the image. Note that the cutoff side to be set here is a position of a cutoff side with respect to an image printed on a first page.

[Step S201R to Step S206R]

In steps S201R to 5206R, the basic operation 2 illustrated above in the column [A] of FIG. 4 is executed, and the control is executed to obtain a recording medium in which a cutoff side E is set on the right side with respect to an image printed on a first page and printing is performed on both sides.

In other words, in step S201R, the image former 104 prints an image of a (4N−1)^{th} page on a left half surface and prints an image of (4N−2)^{th} page on a right half surface of each recording medium St ((1) in column [A] of FIG. 4). Next, in step S202R, the medium feeder 105 executes the front-back reversal in the conveyance direction for the recording medium St ((2) in the column [A] of FIG. 4). Next, in step S203R, the image former 104 prints an image of a (4N−3)^{th} page on a left half surface and prints an image of 4N^{th} page on a right half surface of the recording medium St ((3) in column [A] of FIG. 4).

After that, in step S204R, the cutting processor 106 cuts the recording medium St into two recording media St-1 and St-2 at the center in the conveyance direction ((4) of the column [A] of FIG. 4). Next, in step S205R, the reversing processor 107 executes the front-back reversal in the conveyance direction for the cut recording medium St-1 that is a first sheet, and ejects the recording medium St-1 from the ejection processor 108 ((5) in the column [A] of FIG. 4). Subsequently, in step S206R, the reversing processor 107 conveys, as it is, the recording medium St-2 that is a second sheet in the conveyance direction to the ejection processor 108, and ejects the recording medium St-2 onto the recording medium St-1 that is the first page ((6) in the column [A] of FIG. 4).

[Step S207R to Step S209R]

Furthermore, in subsequent steps S207R to 5209R, processing similar to the processing executed in steps S107R to S109R described above is executed.

[Step S201L to Step S206L]

On the other hand, in a case of determining that the cutoff side is not set on the right side (NO) in step S200, the processing proceeds to step S201L, and control is executed to obtain a double-sided printed matter in which the cutoff side is set on the left side with respect to the image printed on the first page.

In steps S201L to 5206L, the basic operation 2 illustrated above in the column [B] of FIG. 4 is executed, and control is executed to obtain a recording medium in which the cutoff side E is set on the left side with respect to the image printed on the first page and printing is performed on both sides.

In other words, in step S201L, the image former 104 prints an image of a 4N^{th} page on a left half surface and prints an image of (4N−3)^{th} page on a right half surface of the recording medium St ((1) in column [B] of FIG. 4). Next, in step S202L, the medium feeder 105 executes the front-back reversal in the conveyance direction for the recording medium St ((2) in the column [B] of FIG. 4). Next, in step S203L, the image former 104 prints an image of a (4N−2)^{th} page on a left half surface and prints an image of a (4N−1)^{th} page on a right half surface of the recording medium St ((3) in column [B] of FIG. 4).

After that, in step S204L, the cutting processor 106 cuts the recording medium St into two recording media St-1 and St-2 at the center in the conveyance direction ((4) of the column [B] of FIG. 4). Next, in step S205L, the reversing processor 107 conveys, as it is, the cut recording medium St-1 that is a first sheet to the ejection processor 108 and ejects the recording medium St-1 ((5) in the column [B] of FIG. 4). Subsequently, in step S206L, the reversing processor 107 executes the front-back reversal in the conveyance direction for the recording medium St-2 that is a second sheet and ejects, from the ejection processor 108, the recording medium St-2 onto the recording medium St-1 that is the first page ((6) in the column [B] of FIG. 4).

[Step S207L to Step S209L]

Furthermore, in subsequent steps S207L to S209L, processing similar to the processing executed in steps S107R to S109R described above is executed.

According to the above-described control method for the image forming apparatus of the fourth embodiment, it is possible to output printed matters stacked in units of the sets in each of which the recording media St-1 and St-2 are stacked in the page order. Furthermore, it is possible to output the recording media St-1 and St-2 in a state in which the cutoff sides E arranged in the same direction with respect to the images are oriented in the same direction, and there is no need to adjust orientations of the respective cutoff sides E in off-line work.

Meanwhile, it may be possible to add, before or after step S5 illustrated in FIG. 6, a step to determine whether a landscape-mode printed matter is set in the settings of the image forming job although illustration of the step is omitted in the above description of the fourth embodiment. In this case, in a case of determining that the landscape-mode printed matter is set (YES), the input/output controller 103a executes, for example, a step of determining whether a cutoff side is set on a lower side. Then, in a case of determining that the cutoff side is set on the lower side (YES), the basic operation 2 illustrated above in the column [A] of FIG. 5 is executed, and in a case of determining that the cutoff side is not set on the lower side (NO), the basic operation 2 illustrated in column [B] of FIG. 5 is executed. Furthermore, after the basic operation 2, the basic operation 2 may be repeatedly executed by executing processing similar to the above-described processing executed in the steps S107R to S109R.

### Fifth Embodiment

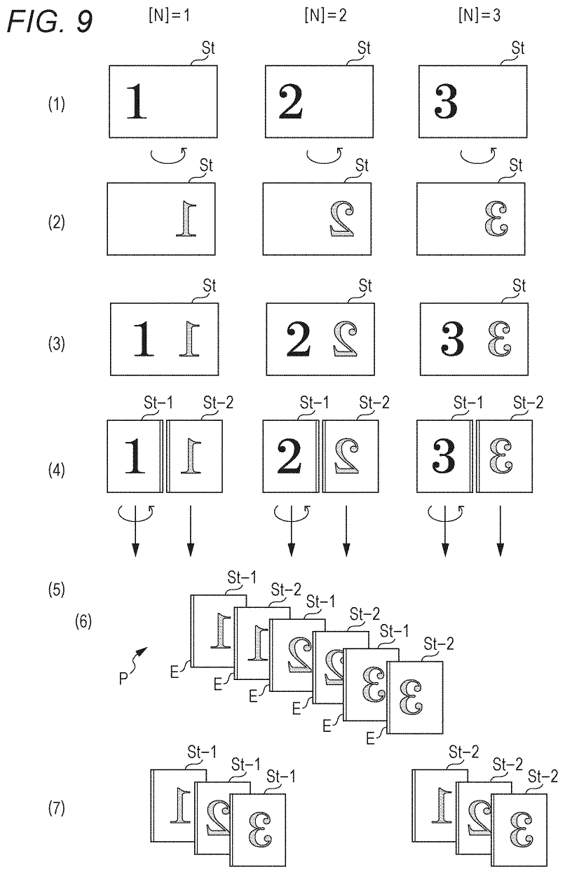

FIG. 9 is a process diagram illustrating a control method for an image forming apparatus of a fifth embodiment, and also is a process diagram in a case of applying a fourth embodiment described above to repeated printing. The control method for the image forming apparatus of the fifth embodiment illustrated in this drawing is a control method in a case of obtaining prescribed number of sets of printed matters P each including a preset plurality of pages by repeatedly imposing and printing same images on one recording medium St. FIG. 9 illustrates a case where a basic operation 1 illustrated in a column [A] of FIG. 3 is applied to the repeated printing to obtain single-sided printed matters P in each of which a cutoff side is set on a right side with respect to an image, and the case is executed as follows.

First, as illustrated in (1) in column [N]=1 of FIG. 9, an image former 104 prints an image of a first page on a left half surface of a recording medium St that is a first-page sheet. Next, as illustrated in (2) of the column [N]=1 of FIG. 9, a medium feeder 105 executes front-back reversal in a conveyance direction for the recording medium St. Next, as illustrated in (3) of the column [N]=1 of FIG. 9, the image former 104 executes the repeated printing of the image of the first page on a left half surface of the recording medium St. After that, as illustrated in (4) of the column [N]=1 of FIG. 9, a cutting processor 106 cuts the recording medium St into two recording media St-1 and St-2 at a center in the conveyance direction. Next, as illustrated in (5) of the column [N]=1 of FIG. 9, a reversing processor 107 executes the front-back reversal in the conveyance direction for the cut recording medium St-1 that is a first sheet, and ejects the recording medium St-1 from an ejection processor 108. Subsequently, as illustrated in (6) of the column [N]=1 of FIG. 9, the reversing processor 107 conveys, as it is, the recording medium St-2 that is a second sheet in the conveyance direction to the ejection processor 108 and ejects the recording medium St-2 onto the recording medium St-1 that is the first sheet.

Consequently, printed matters P in which the recording media St-1 and St-2 each having a cutoff side E on the right side with respect to the image of the first page are stacked in a state in which the image-formed surfaces and the cutoff sides E are oriented in the same direction.

After that, as illustrated sequentially from the top in a column [N]=2 of FIG. 9, processing is executed for a recording medium St that is a second-page sheet (sheet [N]=2] in a procedure similar to the procedure of the first-page sheet ((sheet [N]=1). Note that an image to be printed is an image of a second page. Consequently, printed matters P in which recording media St-1 and St-2 each having a cutoff side E set on a right side with respect to the image of the second page are stacked on the two recording media St-1 and St-2 each having the image of the first page printed in a state in which the image-formed surfaces and the cutoff sides E are oriented in the same direction.

Furthermore, after that, as illustrated sequentially from the top in a column [N]=3 of FIG. 9, processing is executed for a recording medium St that is a third-page sheet (sheet [N]=3) in a procedure similar to the procedure of the first-page sheet ((sheet [N]=1). Note that an image to be printed is an image of a third page. Consequently, printed matters P in which the two recording media St-1 and St-2 each having the image of the first page printed, the two recording media St-1 and St-2 stacked thereon and each having the image of the second page printed, and the recording media St-1 and St-2 each having a cutoff side E set on a right side with respect to the image of the third page are stacked in a state in which the image-formed surfaces and the cutoff sides E are oriented in the same direction.

As described above, according to the control method of the fifth embodiment, it is possible to obtain single-sided printed matters P in which the recording media for all of N pages having the cutoff sides E set on the right side with respect to the respective images are stacked in the page order in a state in which the image-formed surfaces and the cutoff sides E are oriented in the same direction. Accordingly, as illustrated in (7) of FIG. 9, there is no need to adjust the orientations of the image-formed surfaces and the cutoff sides E in off-line work at the time of distributing the respective pages of the recording media in units of the sets.

Note that, in the fifth embodiment, the basic operation 1 illustrated in column [B] of FIG. 3, a basic operation 2 illustrated in FIG. 4, and a basic operation 3 illustrated in FIG. 5 can be applied similarly.

### Sixth Embodiment

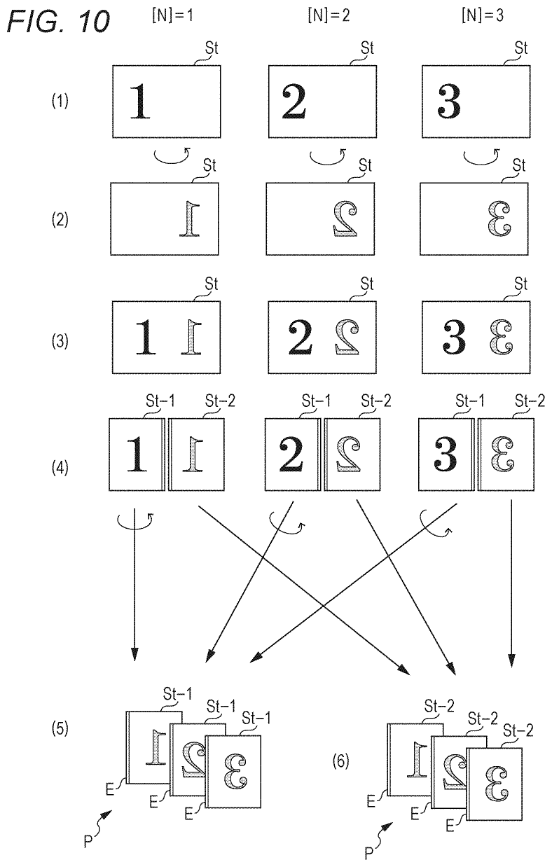

FIG. 10 is a process diagram illustrating a control method for an image forming apparatus of a sixth embodiment, and is a modified example of a fifth embodiment described above. The control method illustrated in FIG. 10 differs from a control method of the fifth embodiment described by using FIG. 9 in that an ejection processor 108 distributes and ejects, into different trays, recording media St-1 and St-2 cut by a cutting processor 106, and a procedure before then is similar to the control method of the fifth embodiment.

In other words, as illustrated above in (1) to (4) in a column [N]=1 of FIG. 10, in the control method for the image forming apparatus of the sixth embodiment, processing is executed similar to the fifth embodiment from when an image is printed on a recording medium St that is a first-page sheet (sheet [N]=1) until the recording medium is cut into the two recording media St-1 and St-2.

After that, as illustrated in (5) of the column [N]=1 of FIG. 10, a reversing processor 107 executes front-back reversal in a conveyance direction for the cut recording medium St-1 that is a first sheet, and conveys the recording medium St-1 to an ejection processor 108. The ejection processor 108 ejects, to a first tray 200a, the recording medium St-1 that is the first sheet conveyed from the reversing processor 107. Subsequently, as illustrated in (6) of the column [N]=1 of FIG. 10, the reversing processor 107 conveys, as it is, the recording medium St-2 that is a second sheet to the ejection processor 108. The ejection processor 108 ejects, to a second tray 200b, the recording medium St-2 that is the second sheet conveyed from the reversing processor 107.

Next, as illustrated sequentially from the top in a column [N]=2 of FIG. 10, processing is similarly executed for a recording medium St (sheet [N]=2] that is a second-page sheet, and recording media St-1 and St-2 that have been cut are distributed and ejected to the first tray 200a and a second tray 200b respectively. Furthermore, after that, as illustrated sequentially from the top in a column [N]=3 of FIG. 10, processing is similarly executed for a recording medium St (sheet [N]=3] that is a third-page sheet, and recording media St-1 and St-2 that have been cut are distributed and ejected to the first tray 200a and the second tray 200b respectively.

As described above, according to the control method of the sixth embodiment, it is possible to obtain single-sided printed matters P in which the recording media for a plurality of pages having cutoff sides E set on a right side with respect to respective images are stacked in the page order in a state in which the image-formed surfaces and the cutoff sides E are oriented in the same direction. Moreover, the printed matters P are output in units of sets after being distributed to the first tray 200a and the second tray 200b, and therefore, there is no need to distribute the respective pages of the recording media in the units of the sets in off-line work.

Note that, in the sixth embodiment, a basic operation 1 illustrated in column [B] of FIG. 3, a basic operation 2 illustrated in FIG. 4, and a basic operation 3 illustrated in FIG. 5 can be applied similarly. Furthermore, in the sixth embodiment, in a case of obtaining three or more sets of the printed matters, it is only to increase the number of trays to which the recording media are distributed and ejected, and execute printing from the first page to a final page repeatedly.

### Seventh Embodiment

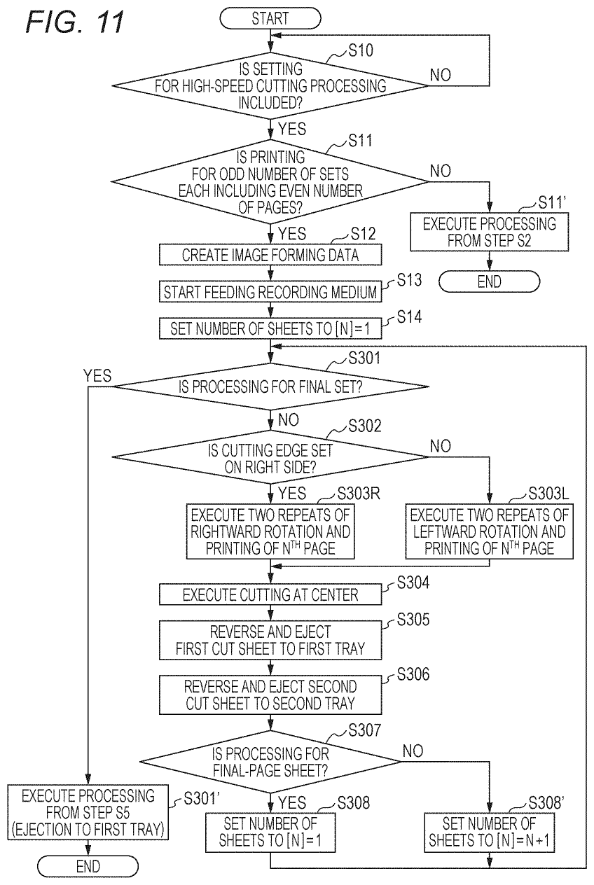

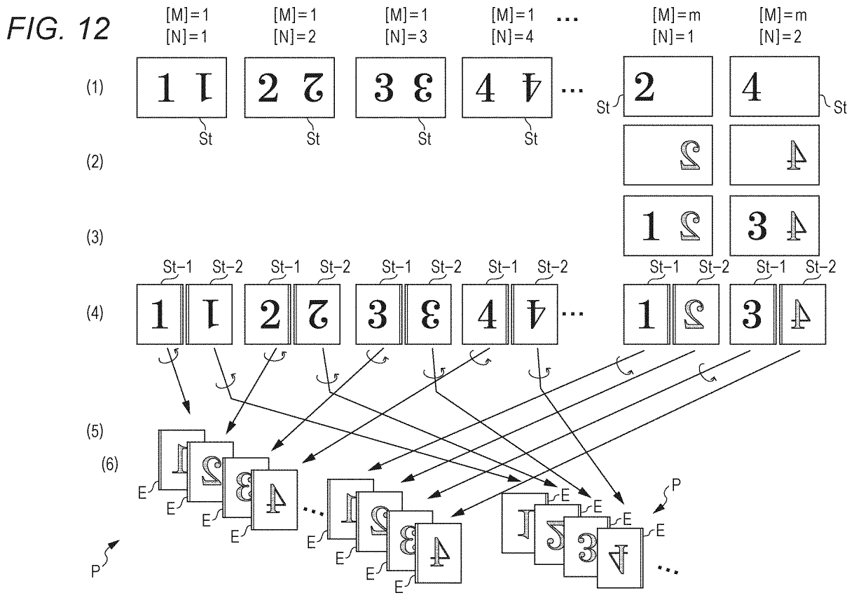

FIG. 11 is a flowchart illustrating a control method for an image forming apparatus of a seventh embodiment. FIG. 12 is a process chart illustrating the control method for the image forming apparatus of the seventh embodiment, and also illustrates an exemplary case of producing a printed matter in which one set is constituted of recording media of total four pages. The control method illustrated in these drawings is the exemplary case in which a control method of a fourth embodiment described above is executed in combination with other control methods. In the following, the control method of the seventh embodiment will be described in the order illustrated in the flowchart of FIG. 11 while referring to FIG. 12 and FIG. 1 and FIG. 2 described above.

[Step S10]

First, in step S10, in a case where an image forming job is input to an image forming apparatus 100 from an operation part 101 or an external device, an input/output controller 103a determines whether settings of the image forming job includes a setting for high-speed cutting processing. The high-speed cutting processing means that there is a setting for cutting a recording medium, and also there is a setting to prioritize printing of an image on only one main surface of a recording medium St as high-speed processing. Note that a setting for cutting to be determined here is a setting to cut the recording medium into, for example, two areas at a center in a longitudinal direction.

In a case where such a setting is made, the input/output controller 103a determines that the setting for cutting is included (YES), and processing proceeds to next step S11. In other cases, the processing returns to step S10 and waits until it is determined that the setting for the high-speed cutting processing is included (YES).

[Step S11]

In step S11, the input/output controller 103a determines whether settings of the input image forming job are print settings to produce the odd number of sets each including printing of images of the even number of pages. In a case where the input/output controller 103a determines that the settings of the image forming job are for the odd number of sets each including the even number of pages (YES), the processing proceeds to step S12. Note that FIG. 12 illustrates the case where the settings of the image forming job are to produce printed matters of five sets each including four pages, and the processing proceeds to step S12.

On the other hand, in a case where the input/output controller 103a determines that the settings of the image forming job are not for the odd number of sets each including the even number of pages (NO), the processing proceeds to step S11′.

[Step S11′]

In step S11′, the input/output controller 103a determines that the high-speed cutting processing is not applicable, and executes processing from step S2 described by using FIG. 6 in the fourth embodiment.

[Step S12]

In step S12, an image forming data generator 103b generates image forming data based on condition settings of the image forming job input from the operation part 101 or the external device. In the image forming data, images are imposed and laid out on a front surface and a back surface of each of the two areas obtained by cutting the recording medium at the center. At this time, the image forming data generator 103b generates the image forming data in which the images are imposed on only the one main surface of some of a plurality of recording media. Here, some of the recording media represent recording media excluding a recording medium constituting a final set. The image forming data generator 103b generates, as the image forming data for some of the recording media, image forming data in which same images are rotated by 180 degrees from each other and imposed on only the one main surface of each recording medium. Furthermore, as image forming data for the recording media constituting the final set, image forming data in which imposition is made so as to execute printing in procedures illustrated in above-described basic operations is generated.

[Step S13]

In step S13, the input/output controller 103a commands a medium feeder 105 to feed a recording medium to an image former 104. Consequently, the medium feeder 105 starts feeding the recording medium to the image former 104.

[Step S14]

In step S14, the input/output controller 103a executes processing to set, to [N]=1, the number of sheets [N] of the recording medium to be printed in this image forming job, and the processing proceeds to next step S301.

[Step S301]

In step S301, the input/output controller 103a determines whether printing processing to be executed next is processing for a final set of the prescribed number of sets preset in the image forming job. In a case of determining that the processing is for the final set (YES), the processing proceeds to step S301′. On the other hand, in a case where the processing is not for the final set (NO), the processing proceeds to step S302.

[Step S302]

In step S302, the input/output controller 103a determines whether a cutoff side is set on a right side in the settings of the input image forming job. In a case of determining that the cutoff side is set on the right side (YES), the processing proceeds to step S303R. On the other hand, in a case of determining that the cutoff side is not set on the right side (NO), the processing proceeds to step S303L. Note that FIG. 12 illustrates a case where the cutoff side is set on the right side with respect to each image in the settings of the image forming job.

[Step S303R]

In step S303R, the image former 104 executes, in accordance with the image forming data generated by the image forming data generator 103b, two repeats of rightward rotation and printing of the same image on one main surface of the recording medium St fed from the medium feeder 105. In other words, here the same image is printed as it is on a left half surface of the recording medium St, and subsequently the same image is rotated by 180 degrees and then printed on a right half surface thereof.

[Step S303L]

On the other hand, in step S303L, the image former 104 executes, in accordance with the image forming data generated by the image forming data generator 103b, two repeats of rightward rotation and printing of the same image on the one main surface of the recording medium St fed from the medium feeder 105. In other words, here the same image is rotated by 180 degrees and then printed on a left half surface of the recording medium St, and subsequently the same image is printed as it is on a right half surface thereof.

[Step S304]

In step S304, a cutting processor 106 cuts, into two recording media St-1 and St-2 at a center in a conveyance direction, the recording medium St conveyed by the medium feeder 105 from the image former 104. Furthermore, the cut recording media St-1 and St-2 are sequentially conveyed to a reversing processor 107.

[Step S305]

In step S305, among the recording media St-1 and St-2 cut into two sheets, the reversing processor 107 executes front-back reversal in the conveyance direction for the recording medium St-1 positioned at a first sheet (on a leading end side) in the conveyance direction and conveys the recording medium St-1 to an ejection processor 108. The ejection processor 108 ejects, to a first tray 200a, the recording medium St-1 that is the first sheet conveyed from the reversing processor 107.

[Step S306]

In step S306, among the recording media St-1 and St-2 cut into the two sheets, the reversing processor 107 executes the front-back reversal in the conveyance direction for the recording medium St-2 positioned at a second sheet (on a tail end side) in the conveyance direction and conveys the recording medium St-2 to an ejection processor 108. The ejection processor 108 ejects, to a second tray 200b, the recording medium St-2 that is the second sheet conveyed from the reversing processor 107.

[Step S307]

In step S307, the input/output controller 103a determines whether the processing in steps S302 to S306 executed earlier is processing for a final-page sheet of a set, in other words, whether the processing is for processing to produce a final page of the set. In a case of determining that the processing is for the final-page sheet of the set (YES), the processing proceeds to step S308R. On the other hand, in a case of determining that the processing is not for the final-page sheet of the set (NO), the processing proceeds to step S308W.

[Step S308]

In step S308, the input/output controller 103a executes processing to set the number of sheets to [N]=1, and returns to earlier step S301 to repeat the subsequent steps.

[Step S308′]

In step S308′, the input/output controller 103a executes processing to set the number of sheets to [N]=N+1, and returns to the earlier step S301 to repeat the subsequent steps.

In the above-described manner, as illustrated in a column “[M]=1 and [N]=1” to a column “[M]=1 and [N]=4” in FIG. 12, single-sided printed matters in each of which recording media St-1 and St-2 are stacked in the page order are distributed and output to the first tray 200a and the second tray 200b respectively in a state that image-formed surfaces and cutoff sides E are oriented in the same direction by the processing of printing the images on the one main surface of each of the recording media St. Note that, in FIG. 12, [M]=1 represents the number of sets.

[Step S301′]

On the other hand, in step S301′ that is the step after the input/output controller 103a determines that the processing is for the final set (YES) in step S301, the input/output controller 103a executes processing from step S5 described above in the fourth embodiment by using FIG. 6. Consequently, as illustrated in the column “[M]=m and [N]=1” to the column of “[M]=m and [N]=2” in FIG. 12, the single-sided printed matters in each of which recording media St-1 and St-2 are stacked in the page order are output to one of the trays in the state in which the image-formed surfaces and the cutoff sides E are oriented in the same direction by the procedure described in the fourth embodiment. Note that, in FIG. 12, [M]=m represents the number of sets and also the final set.

As described above, according to the control method of the seventh embodiment, the images are printed only on the one main surface side of each recording medium St in the processing excluding the processing for the final set. Therefore, it is possible to omit time consuming work to reverse each recording medium St and print images on front and back sides thereof. Therefore, with the execution of the image forming job including the cutting processing, productivity can be improved by faster processing of the image forming job in the case of obtaining the single-sided printed matters stacked in the page order in the state in which the image-formed surfaces and the cutoff sides E are oriented in the same direction. Moreover, according to the control method of the seventh embodiment, waste of a recording medium can be reduced in a case of producing printed matters P of the odd number of sets each including the even number of pages, and the productivity can be improved also in this point.

Although embodiments of the present invention have been described and illustrated in detail, the disclosed embodiments are made for purposes of illustration and example only and not limitation. The scope of the present invention should be interpreted by terms of the appended claims.

What is claimed is:

1. An image forming apparatus comprising:
an image former that forms an image on a sheet-like recording medium;
a cutting processor that cuts, into a plurality of divided areas, a recording medium conveyed from the image former;
a reversing processor having a function to reverse the recording medium cut by the cutting processor; and
an image forming data generator that generates image forming data in which an image to be formed on the recording medium is imposed in each of the divided areas, wherein
the image forming data generator generates, based on settings of an image forming job, the image forming data in which the images are imposed on a front surface and a back surface of the recording medium before the cutting such that cutoff sides of recording media after the cutting are arranged in a same direction with respect to the images formed on the recording media after the cutting,
the image former forms the images on the front surface and the back surface of the recording medium based on the image forming data, and
the reversing processor aligns the cutoff sides of the recording media after the cutting, by executing front-back reversal for some of the recording media cut into a plurality of sheets by the cutting processor.

2. The image forming apparatus according to claim 1, wherein
the cutting processor cuts the recording medium into two at a center in a conveyance direction of the recording medium, and
the reversing processor executes front-back reversal in the conveyance direction for the recording media after the cutting.

3. The image forming apparatus according to claim 1, wherein
the image forming data generator generates image forming data in which layouts of images imposed on the front surface and the back surface of the recording medium before cutting are swapped in accordance with an arrangement direction of the cutoff sides with respect to the images, and
the reversing processor switches, among the recording media after the cutting, a recording medium to be reversed in accordance with the arrangement direction of the cutoff sides with respect to the images.

4. The image forming apparatus according to claim 1, wherein
in a case where the conveyance direction of the recording medium is a vertical direction of an image formed on the recording medium,
the image forming data generator generates image forming data in which images to be imposed on the front surface and the back surface of the recording medium before the cutting are rotated by 90 degrees in accordance with the arrangement direction of the cutoff sides with respect to the images.

5. The image forming apparatus according to claim 1, further comprising
an ejection processor having a function to distribute and eject, to different ejecting destinations, respective recording media conveyed from the reversing processor, wherein
in a case where same images are formed in the plurality of divided areas set in the recording medium,
the ejection processor distributes and outputs, to a plurality of ejecting destinations, the recording media after the cutting.

6. The image forming apparatus according to claim 1, wherein
in a case of forming images of a plurality of pages in a plurality of divided areas set in a plurality of the recording media,
the image forming data generator generates image forming data in which the images are imposed on only one surface of some of the plurality of recording media.

7. The image forming apparatus according to claim 6, wherein
the image forming data generator generates image forming data in which same images rotated by 180 degrees from each other are imposed only on one surface of the recording medium as image forming data for recording media excluding recording media constituting a final set among the plurality of recording media.

8. The image forming apparatus according to claim 6, further comprising
an operation part at which settings of an image forming job are input, wherein
in a case where a setting to prioritize image formation only on one main surface of the recording medium is input at the operation part, the image forming data generator generates image forming data in which images are imposed only on the one main surface for some of the plurality of recording media.

9. A control method for an image forming apparatus including:
an image former that forms an image on a sheet-like recording medium;
a cutting processor that cuts, into a plurality of divided areas, a recording medium conveyed from the image former;
a reversing processor having a function to reverse the recording medium cut by the cutting processor; and
an image forming data generator that generates image forming data in which an image to be formed on the recording medium is imposed in each of the divided areas,
the control method comprising:
generating, by the image forming data generator, image forming data in which images are imposed on a front surface and a back surface of the recording medium before the cutting based on settings of an image forming job such that cutoff sides of recording media after the cutting are arranged in a same direction with respect to the images formed on the recording media after the cutting;
forming, by the image former, the images on the front surface and the back surface of the recording medium based on the image forming data generated in the image forming data generator; and
aligning, by the reversing processor, the cutoff sides of the recording media after the cutting, by executing front-back reversal for some of the recording media cut into a plurality of sheets by the cutting processor.

10. A non-transitory recording medium storing a computer readable control program of an image forming apparatus executed by a hardware processor that controls the image forming apparatus including:
an image former that forms an image on a sheet-like recording medium;
a cutting processor that cuts, into a plurality of divided areas, a recording medium conveyed from the image former;
a reversing processor having a function to reverse the recording medium cut by the cutting processor; and
an image forming data generator that generates image forming data in which an image to be formed on the recording medium is imposed in each of the divided areas,
the non-transitory recording medium storing the computer readable control program causing the hardware processor to execute:
generating, by the image forming data generator, image forming data in which images are imposed on a front surface and a back surface of the recording medium before the cutting based on settings of an image forming job such that cutoff sides of recording media after the cutting are arranged in a same direction with respect to the images formed on the recording media after the cutting;
forming, by the image former, the images on the front surface and the back surface of the recording medium based on the image forming data generated in the image forming data generator; and
aligning, by the reversing processor, the cutoff sides of the recording media after the cutting, by executing front-back reversal for some of the recording media cut into a plurality of sheets by the cutting processor.
